(19) United States
(12) Patent Application Publication
(10) Pub. No.: US 2026/0316322 A1
(43) Pub. Date: Oct. 15, 2026

(54) DEVICE FOR TRIMMING PANEL EDGES

(71) Applicant: CONSTRUCCIONES ESPANOLAS DE HERRAMIENTAS INDUSTRIALES, S.A., Caldes De Montbui (ES)

(72) Inventors: ISAAC BURGOS LOZANO, CASTELLTERCOL (ES); Pedro PEREZ SAAVEDRA, LA FONT DE TERRASSA (ES); Eduard COLETAS NAVARRO, BARCELONA (ES)

(21) Appl. No.: 19/482,704

(22) PCT Filed: May 9, 2023
(86) PCT No.: PCT/ES2023/070296

§ 371 Date: Nov. 7, 2025

(51) Int. Cl. B27D 5/00

(52) U.S. Cl. CPC B27D 5/006

(57) ABSTRACT

The invention relates to a device for trimming panel edges, which comprises a first trimming unit (10) for trimming the front end (C1) and the bottom end (C2), and a second trimming unit (20) for trimming the upper end (C3) and the rear end (C4), of an edge (C) of a panel (P) by means of respective milling cutters (108, 208). The trimming units (10, 20) comprise a first actuator and a second actuator (102, 202) that make contact with the panel (P) and four lateral copiers (110, 111, 210, 211) that make contact with the edge during the trimming of the respective ends of the edge (C). The lateral copiers can be independently arranged in a forward position or in a rear position, in which positions the milling cutters of the trimming units (10, 20) make a straight cut or a rounded cut, respectively, in the corresponding end (C1-C4) of the edge.

### TECHNICAL FIELD

The present invention relates to a device for trimming panel edges, applicable in veneering machines which perform veneering on the sides of panels of various materials, such as wood, plywood, medium density fiberboard (MDF), chipboard, or the like.

In particular, the device in question is adapted to perform with a single group the trimming of the front, bottom, top and rear borders of the edge applied on one side of the panel; and to select separately the type of trimming, in straight or radius, of each of the borders of the edge.

### PRIOR ART

Nowadays, veneering machines with different working units are well known in the market, depending on the finish to be given to the panel to be worked. The number of working units included in these veneering machines depends on the production to be achieved and the finish to be given to the final product.

These veneering machines generally have four basic working units: specifically, a gluing unit that applies hot melt glue to the side of the panel where the edge is to be applied, a pressure unit that presses the edge against the glued side of the panel, a trimming unit for the front and rear ends of the edge, and a trimming unit for the top and bottom ends of the edge.

Additionally, these veneering machines may comprise other working groups, for example a rounding group in charge of rounding the four vertexes defined on the edge during the trimming of the two front and rear ends and the two upper and lower ends of the edge.

The use in these veneering machines of two working units spaced in the panel feed direction, one of them for trimming the front and rear ends of the edge and the other for trimming the upper and lower ends of said edge, present different disadvantages among which it is worth mentioning the increase of the space required for their location and consequently of the total length of the veneering machine, taking into account that said working units have adequate means for their displacement in the panel feed direction.

It is also common for the above-mentioned working units to have different cutting tools for cutting the front and rear ends of the edge and for cutting the top and bottom ends of the edge.

In this type of veneering machines, it is well known the use of a cutting disc for trimming the front and back edges of the edge, and of a cutter whose cutting edge has a straight front section and a curved back section for trimming the upper and lower ends of the edge. The combined use of these cutting tools requires the use of suitable means to precisely control their movements in the vertical, horizontal and lateral directions.

Therefore, the technical problem is the development of a panel edge trimmer control device of greater constructive simplicity, which allows the trimming of the four ends (front, bottom, top and back) of the edge and significantly reduces the space required for its implementation in the veneer machine, eliminating the possible risks of interference that occur in the two working units currently used for the trimming of these ends of the panel.

### DISCLOSURE OF THE INVENTION

The device for trimming panel edges object of this invention, being of the type described in the preamble of the first claim presents the particularity of comprising a single trimming group suitable for trimming the four front, lower, upper and rear ends of the edge fixed to one side of the panel.

Said single edge trimming unit comprises a first trimming unit for the front and lower end of the edge fixed to the side of the panel and a second trimming unit for the upper and rear end of the edge, each of said trimming units having a cutter with a cutting edge having a straight front section and a curved-concave rear section, for defining a straight or radius profile on the trimmed edges of the edge.

The two trimming units are mounted on a common base and in close proximity to each other, thus minimizing the space occupied by the trimming device.

According to the invention the first trimming unit in charge of trimming the upper end and the rear end of the edge comprises: a first sliding support which is mounted on first sliding guides in the XZ plane and connected to a first actuator and a first trimming head, mounted on said first support with possibility of displacement in the direction of a Y-axis, perpendicular to the direction of advance of the panel with respect to the trimming device.

Said first sliding support comprises means for positioning and fixing a first copying device comprising: a rear end suitable for contacting the front end of the panel in a first trimming position of the front end of the edge, and an upper horizontal end suitable for contacting the bottom end of the panel in a second trimming position of the bottom end of the edge.

For its part, the first trimming head comprises: a first rotating cutter arranged in a plane perpendicular to the “Y” axis and driven by a first motor; a first edge side copier in the first trimming position of the front end of the edge; a second edge side copier in the second trimming position of the lower end of the edge; independent means of positioning and fixing the first side copying device and the second side copying device in a delayed position or in a forward position, in which the curved-concave rear section and the straight front section of the cutting edge of the cutter are respectively arranged in an operative position of trimming the end of the edge, in radius or in straight.

The second trimming unit in charge of trimming the top and the back end of the edge, comprises: a second sliding support mounted on second sliding guides in the XZ plane and connected to a second actuator; and -a second trimming head, mounted on said second support with the possibility of displacement in the Y-axis direction.

Said second sliding support comprises means for positioning and fixing a second copying device comprising: a lower end suitable for contacting the upper end of the panel in a third position of trimming the upper end of the edge, and a vertical front end suitable for contacting the rear end of the panel in a fourth position of trimming the rear end of the edge.

The second trimming head for the top and back edge trimming comprises: a second rotating cutter arranged in a plane perpendicular to the “Y” axis and driven by a second motor; a third lateral edge trimmer in the third trimming position of the top edge trimming end; a fourth lateral edge trimmer in the fourth trimming position of the back edge trimming end.

This second trimming head also has independent means of positioning and fixing the third side copying device and the fourth copying device in an advanced position or in a delayed position, in which the straight front section and the curved-concave rear section of the cutting edge of the cutter are arranged in each trimming operating position respectively in straight or in radius of the edge end.

The incorporation in the trimming device of four lateral edge trimmers, and of independent means for their arrangement in an advanced position or in a delayed position in the direction of the Y axis, perpendicular to the forward axis of the panel, in the trimming positions of each of the ends (front, bottom, top and back) of the edge allows to choose the type of trimming, straight profile or radius profile, to be performed on each of the said ends of the edge and on the top end of the edge.

The means of positioning and fixing the side copying devices can be manually operated or of any other type: mechanical, pneumatic, hydraulic or electric, as this does not affect the operation of the trimming device.

Advantageously the rear end and the upper end of the first copying device converge in an area distant from the horizontal projection, in the Y-axis direction, of the turning path of the cutting edge of the first cutter and, similarly the lower end and the front end of the second copying device converge in an area distant from the horizontal projection, in the Y-axis direction, of the turning path of the cutting edge of the second cutter.

These characteristics provide a technical effect, consisting in that during the passage from the first trimming position of the front end of the edge to the second trimming position of the lower end of the edge, the front-bottom corner of the edge is distanced from the cutting path of the first cutter preventing the rounding of this corner, and that during the passage from the third trimming position of the upper end of the edge to the fourth trimming position of the rear end of the edge, the upper-rear apex of the edge is kept out of the cutting path of the second cutter, preventing the rounding of said apex.

Advantageously and in accordance with the invention the first guides and the second guides of the first trimming unit and of the second trimming unit are parallel, are arranged in the XZ plane and inclined with respect to the X axis.

The second guides are spaced in the X-axis direction with respect to the first guides and close to each other, so that the first and second trimming unit can slide on these guides without risk of interference during trimming of the edge ends.

An additional advantage is that the trimming of the lower end of the edge and the upper end of the edge is, for the most part, performed simultaneously by the first trimming unit and the second trimming unit, minimizing the trimming time of the panel edge.

The inclined arrangement of the guides provides several advantages, including: the reduction of the overall length of the trimming device compared to working units that use horizontal and vertical guides for their displacement, and that two linear actuators parallel to the front and rear guides are sufficient to simultaneously cause a displacement of the trimming units with a horizontal and a vertical component.

Preferably the inclination of said guides is 45°, whereby the displacement of the trimming units in the X-direction and in the Y-direction are of the same amplitude.

### BRIEF DESCRIPTION OF THE CONTENTS OF THE DRAWINGS

To complement the description being made and in order to facilitate the understanding of the characteristics of the invention, the present specification is accompanied by a set of drawings in which the following has been illustrated in an illustrative and non-limiting way:

FIGS. 1a and 1b each show a perspective view of an example embodiment of the edge trimming device according to the invention.

FIGS. 2a and 2b show plan and elevation views of a panel on which is fixed, on one of its sides, an edge whose front, bottom, top and rear ends, to be trimmed, protrude from the contour of that side of the panel.

FIGS. 3a and 3b each show enlarged details of the front edge trimming area with the first side copying device in a delayed position and in an advanced position in the Y-axis direction, respectively.

FIG. 4a shows an elevation view of the trimming device with the first trimming unit in a first trimming position of the front end of an edge applied on a side of a panel.

FIG. 4b corresponds to a horizontal section of the trimming device, along the plane A-A marked in FIG. 4a.

FIG. 5a shows an elevation view of the trimming device, with the first trimming unit in a second position trimming the lower end of the edge.

FIG. 5b corresponds to a vertical section of the trimming device, along the B-B plane marked in FIG. 5a.

FIG. 6a shows an elevation view of the trimming device with the second trimming unit in a third trimming position of the upper end of the edge.

FIG. 6b shows a profile view of the trimming device in the same position as in FIG. 6a, viewed from the side corresponding to the front end of the panel.

FIG. 7a shows an elevation view of the trimming device with the second trimming unit in a fourth trimming position of the back end of the edge.

FIG. 7b corresponds to the horizontal section of the trimming device along the C-C plane marked in FIG. 7a.

### DETAILED DESCRIPTION OF EMBODIMENTS OF THE INVENTION

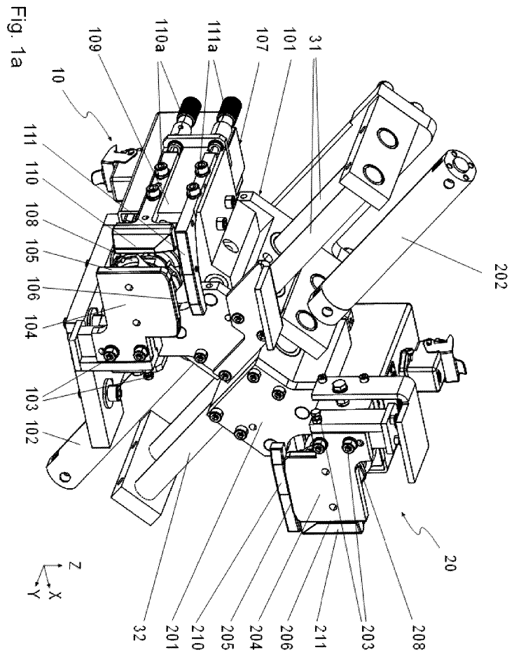

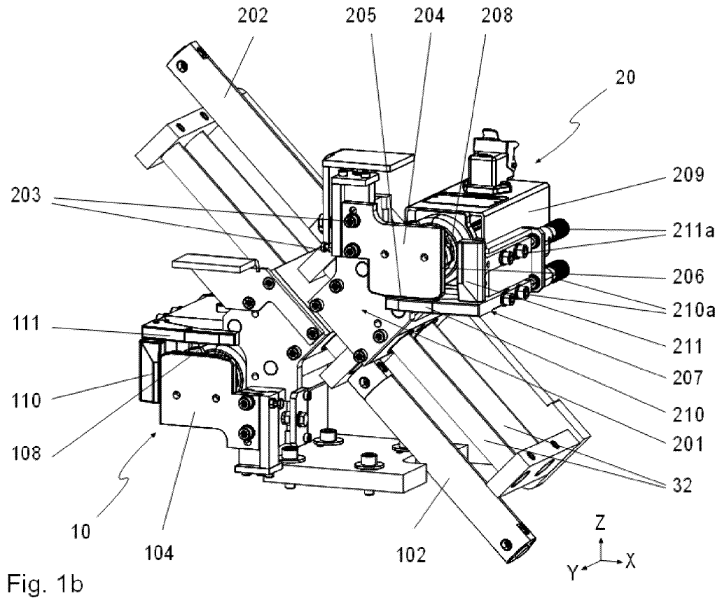

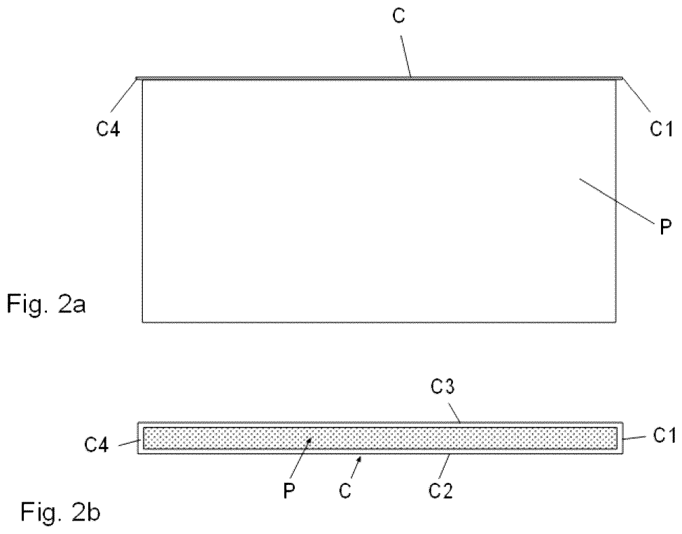

As can be seen in FIGS. 1 and 2, the device for trimming panel edges comprises a trimming unit having a first trimming unit (10) and a second trimming unit (20) mounted respectively, with the possibility of sliding in an XZ plane, on first guides (31) and second guides (32), close and parallel, fixed on a common base.

As will be explained below, the first trimming unit (10) is responsible for trimming the front (C1) and bottom (C2) ends of an edge (C) fixed on a side of a panel (P), as shown in FIGS. 2a and 2b, and which is linearly displaced in a direction X; while the second trimming unit (20) is responsible for trimming the top (C3) and rear (C4) ends of said edge (C) during said linear displacement of the panel (P).

The first trimming unit (10) comprises a first sliding support (101), mounted on the first guides (31) and connected to a first actuator (102) represented in this case by a cylinder parallel to said first guides (31).

Said first support (101) comprises means (103) for positioning and fixing a first copying device (104) provided with a rear end (105) and an upper end (106) which form means of contact with the front end and with the lower surface of the panel (P), during the trimming of the front end (C1) and of the lower end (C2) of the edge (C) respectively.

In the example shown, said means (103) for positioning and fixing the first copying device (104) consist of adjusting screws in the vertical direction of the Z-axis and in the horizontal direction of the X-axis.

Said first trimming unit (10) comprises a first trimming head (107) mounted on the first support (101) with possibility of displacement in the Y-axis direction by the action of a pusher (not shown), which in this case is constituted by a helical spring.

Said first trimming unit (10) comprises; a first rotating cutter (108) arranged in a plane perpendicular to the “Y” axis and driven by a first motor (109); a first side copying tool (110) and a second side copying tool (111) respectively contacting the edge (C) in the first trimming position of the front end (C1) and in the second trimming position of the lower end (C2) of the edge.

This first trimming unit (10) comprises independent means (110a, 111a) for positioning and fixing the first side copier (110) and the second side copier (111) in an advanced position or in a delayed position in the Y-axis direction, wherein the first cutter (108) performs the edge trimming with the straight front section (108a) of the cutting edge of the cutter, or with the curved-concave rear section (108b) of the cutting edge.

Said independent means (110a and 111a) of positioning and fixing of the side copying devices (110, 111) are represented in this example of realization by manually operated positioning screws and fixing screws; however, said independent means (110a and 111a) may be constituted by pneumatic, hydraulic, electric or any other type of actuators which allow to arrange them in the positions, advanced or retarded, mentioned above.

The second trimming unit (20) responsible for trimming the upper end (C3) and the rear end (C4) of the edge (C), applied on the side of the panel (P), is movable in the XZ plane and comprises a second support (201) mounted on second sliding guides (32) and connected to a second actuator (202), consisting of a cylinder parallel to said second guides (32).

Said second support (201) comprises means (203) for positioning and fixing a second copying device (204) visible in FIG. 1b. Said second copying device (204) comprises a lower end (205) suitable for contacting the upper surface of the panel (P) at a third trimming position of the lower end (C3) of the edge, and a front end (206) suitable for contacting the rear end of the panel (P) at a fourth trimming position of the rear end (C4) of the edge.

In the embodiment shown the means (203) for positioning and fixing the second copying device (204) also consist of adjusting screws.

The second trimming unit (20) comprises a second trimming head (207) of the upper (C3) and rear (C4) ends of the edge, mounted on the second support (201) with possibility of displacement in the Y-axis direction by the action of a pusher constituted by a helical spring (not shown).

Said second trimming head (207) comprises: a second rotating cutter (208), analogous to the one used in the first trimming unit (10), arranged in a plane perpendicular to the “Y” axis and driven by a second motor (209); a third side copying device (210) of the edge (C) in the third trimming position of the upper end (C3) of said edge (C) and a fourth side copying device (211) of the edge in the fourth trimming position of the rear end (C4) of the edge.

This second trimming unit (20) has independent means (210a, 211a) for positioning and fixing the third side copying device (210) and the fourth side copying device (211) in an advanced position or in a delayed position in the Y-axis direction, in which the second cutter (208) performs the trimming of the edge (C) with the straight front section (208a) or with the curved-concave rear section (208b) of the cutting edge.

In this case the aforementioned independent means (210a, 211a) consist of adjusting and fastening screws.

Advantageously, as shown in the figures, the first guides (31) and the second sliding guides (32) of the first trimming unit (10) and the second trimming unit (20) are arranged parallel in the XZ plane and at an inclination of 45 degrees with respect to the horizontal.

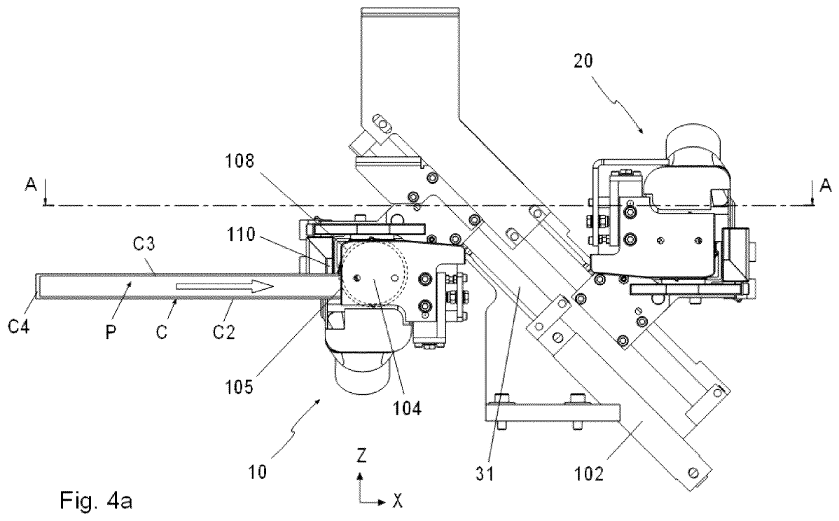

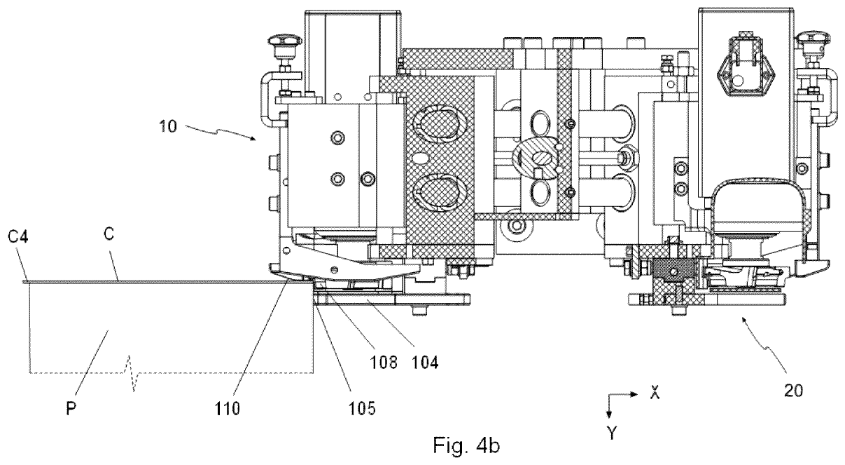

The mode of operation of the edge trimming device is as shown in FIGS. 4 to 7, and is detailed below.

Before starting the work cycle, the positions of the first copying tool (104) and the second copying tool (204) are adjusted horizontally and vertically with the screws forming the respective positioning and fixing means (103, 203), so that their respective rear and upper ends (105, 106), and lower and front ends (205, 206) supporting the panel (P) in the respective trimming positions, conform to the cutting edge path of the first cutter (108) and the second cutter (208).

Each of the side copying devices (110, 111, 210, 211) is also arranged in an advanced position or in a delayed position on the Y-axis, depending on the type of cutout, straight or radius profile, to be made at each of the ends (C1, C2, C3 and C4) of the edge (C).

Once these adjustments are made, when the panel (P) is moved in the X-axis direction as shown in FIGS. 4a and 4b, the front end of the panel (P) contacts the rear end (105) of the first copying unit (104) and the first side copying unit (110) contacts in a Y-axis direction with the edge (C), the first trimming unit (10) being arranged in a first trimming position of the front end (C1) of the edge (C).

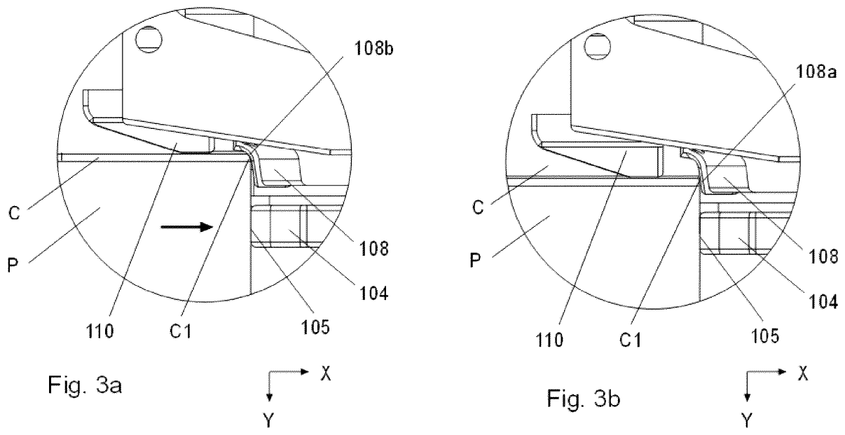

As the panel (P) advances the first trimming unit (10) descends along the first guides (32), the first cutter (108) performing the trimming of the front end (C1) of the edge (C), either with the curved-concave rear section (108b) of the edge as shown in FIG. 3a, or with the straight front section (108a) of the edge as shown in FIG. 3b; depending on whether the first side copying device (110) is arranged in the rear or front position, respectively.

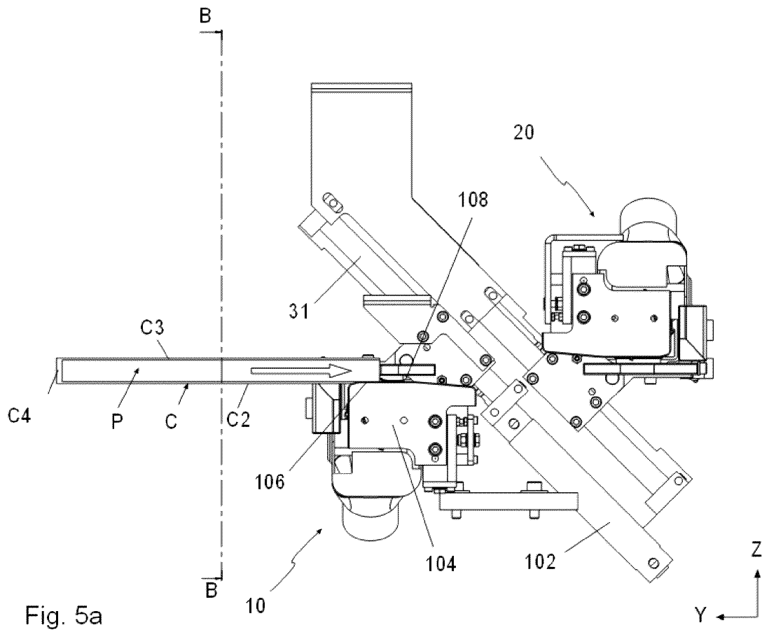

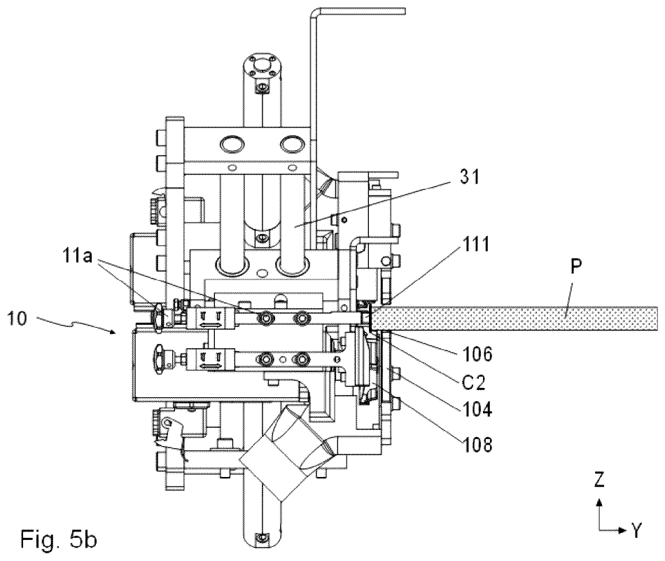

As shown in FIGS. 5a, 5b, when the first cutter (104) reaches a certain height, due to the lowering of the first trimming unit (10) by the first guides (31), said first cutter (104) acts with its upper end (106) against the lower surface of the panel (P) and the second side cutter (111) acts, in the direction of the Y-axis, against the edge (C), said first trimming unit being placed in a second trimming position of the lower end (C2) of the edge (C) by the first cutter (108).

As shown in FIG. 5a, the rear end (105) and the upper end (106) of the first copying unit (104) converge in an area distanced from the horizontal projection of the turning path of the cutting edge of the first cutter (108)—represented with a dashed line—so that when the first trimming unit (10) passes from the first trimming position of the front end (C1) to the second trimming position of the lower end (C2) of the edge, the front—lower vertex of the panel (P) remains distanced from the horizontal projection of the turning path of the cutting edge of the first cutter (108)—represented with a dashed line, the front—bottom vertex of the panel (P) is kept at a distance from said turning path of the edge of the first cutter (108), avoiding the rounding of said vertex.

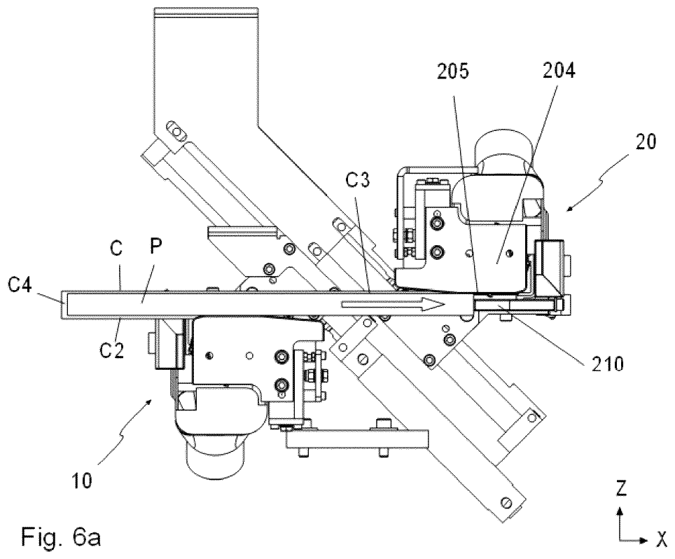

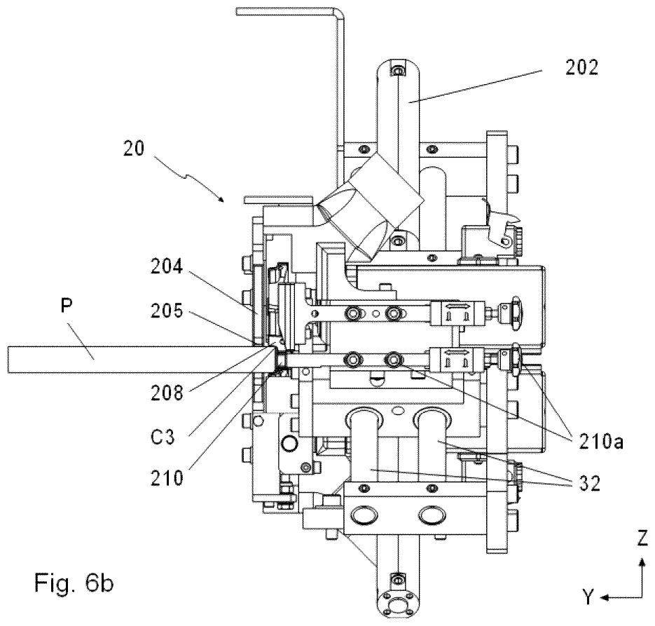

FIGS. 6a and 6b show a device in a third trimming position of the upper end (C3) of the edge by the second trimming unit (20); in said third trimming position the second copying unit (204) acts with its lower end (205) against the upper surface of the panel (P) and the third lateral copying unit (210) acts in the Y-axis direction against the edge (C), the second cutter (208) performing the trimming of said upper end (C3) of the edge as the panel (P) continues its advance in the X-axis direction.

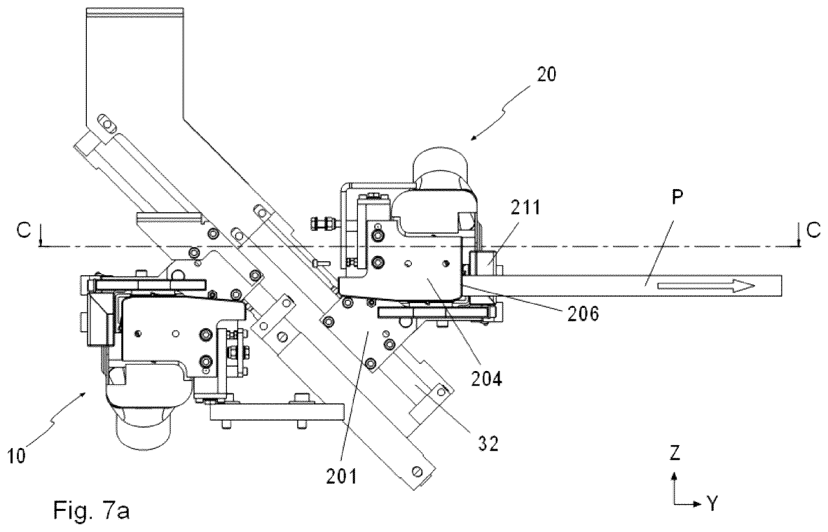

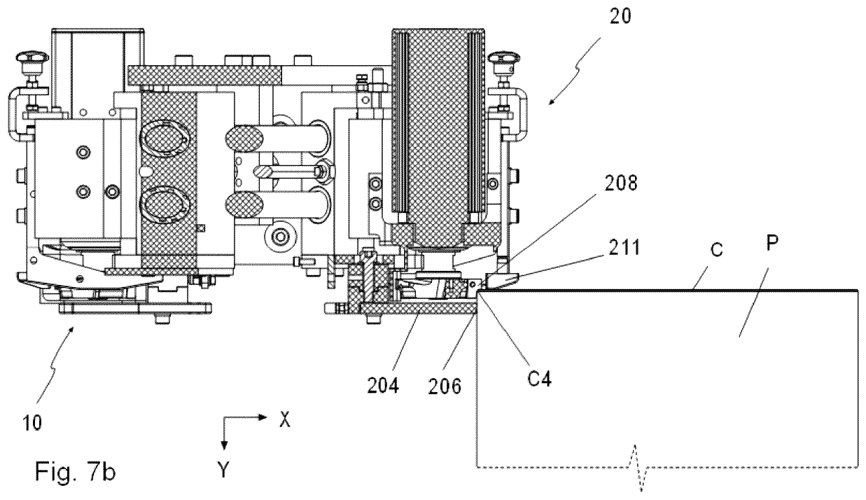

As shown in FIGS. 7a and 7b, when the rear end of the panel (P) passes the lower end (205) of the second copying unit (204), the second trimming unit (20) descends through the second guides (32) passing to a fourth trimming position of the rear end (C4) of the edge (C) of the panel.

In this fourth position the second copying cutter (204) acts with its front surface against the rear end of the panel (P) and the fourth lateral copying cutter (211) acts in the direction of the axis (Y) against the edge (C), the second cutter (208) performing the trimming of the rear end (C4) of the edge (C).

It should be mentioned that the expressions: anterior, superior, inferior, and posterior, as well as the directions of the X, Y, Z axes should be interpreted as positional references intended to facilitate the explanation of the invention, but not as limiting the invention.

Having sufficiently described the nature of the invention, as well as an example of preferred embodiment, it is hereby stated for the appropriate purposes that the materials, shape, preferred embodiment, it is hereby stated for the appropriate purposes that the materials, shape, size and arrangement of the elements described may be modified, provided that this does not entail an alteration of the essential features of the invention claimed below.

1. Device for trimming panel edges, comprising at least one rotating cutter (108, 208) driven by a motor (109, 209) and suitable for trimming at least one end of an edge (C) fixed to a side of a panel (P); characterized in that it comprises a single trimming group for trimming the ends (C1, C2, C3, C4), front, bottom, top and rear of an edge (C) fixed to a side of a panel (P); said trimming group comprising:
a first trimming unit (10) of the front end (C1) and the lower end (C2) of the edge (C), comprising:
a first support (101) sliding connected to a first actuator (102), mounted on first sliding guides (31) in the XZ plane and provided with means (103) for positioning and fixing a first copying device (104) comprising: a rear end (105) suitable for contacting the front end of the panel (P) in a first trimming position of the front end (C1) of the edge (C), and an upper end (106) suitable for contacting the lower end of the panel (P) in a second trimming position of the lower end (C2) of the edge (C),
a first trimming head (107), mounted on the first support (101) with possibility of displacement in the direction of the “Y” axis, and comprising: a first rotating cutter (108) arranged in a plane perpendicular to the “Y” axis provided with a cutting edge with a straight front section (108a) and a curved-concave rear section (108b), and driven by a first motor (109); a first side copying device (110) of the edge (C) in the first trimming position of the front end (C1) of the edge (C); a second side copying device (111) of the edge (C) in the second trimming position of the lower end of the edge; independent means (110a, 111a) for positioning and fixing the first side copying device (110) and the second side copying device (111) in a forward position or in a delayed position in the Y-axis, wherein the straight front section (108a) and the curved-concave rear section (108b) of the cutting edge are arranged respectively in a trimming position, in straight or in radius, of the end (C1, C2) of the edge (C) to be trimmed,
a second trimming unit (20) of the upper end (C3) and the rear end (C4) of the edge (C), and comprising:
a second sliding support (201) connected to a second actuator (202), mounted on second sliding guides (32) in the XZ plane and provided with means (203) for positioning and fixing a second copying device (204) comprising: a lower end (205) suitable for contacting the upper end of the panel (P) in a third trimming position of the upper end (C3) of the edge, and an anterior end (206) suitable for contacting the rear end of the panel (P) in a fourth trimming position of the rear end (C4) of the edge (C);
a second trimming head (207) of the upper end (C3) and of the rear end (C4) of the edge (C), mounted on the second support (201) with the possibility of displacement in the XZ plane, and comprising a second rotating cutter (208) arranged in a plane perpendicular to the “Y” axis, provided with a cutting edge with a straight front section (208a) and a curved-concave rear section (208b) and driven by a second motor (209); a third side copying device (210) of the edge (C) at the third trimming position of the upper end (C3) of said edge; a fourth side copying device (211) of the edge (C) at the fourth trimming position of the rear end (C4) of the edge; independent means (210a, 210b) for positioning and fixing the third side copying device (210) and the fourth side copying device (211) in an advanced position or in a delayed position in the Y-axis direction, wherein the straight front section and the curved-concave rear section of the cutting edge are respectively arranged in a trimming position, in straight or in radius, of the end (C3, C4) of the edge to be trimmed.

2. Device according to claim 1, wherein the rear end (105) and the upper end (106) of the first copying device (104) converge in an area distant from the horizontal projection, in the Y-axis direction, of the turning path of the cutting edge of the first cutter (108).

3. Device according to claim 1, wherein the lower end (205) and the front end (206) of the second copying device (204) converge in an area distant from the horizontal projection, in the Y-axis direction, of the turning path of the cutting edge of the second cutter (208).

4. Device according to claim 1, wherein the first guides (31) of the first trimming unit (10) and the second guides (32) of the second trimming unit (20) are arranged in the XZ plane and inclined with respect to the X axis.

5. Device according to claim 4, wherein the first guides (31) and the second guides (32) are parallel and form with the X-axis an angle of 45°.

6. Device according to claim 2, wherein the lower end (205) and the front end (206) of the second copying device (204) converge in an area distant from the horizontal projection, in the Y-axis direction, of the turning path of the cutting edge of the second cutter (208).

7. Device according to claim 2, wherein the first guides (31) of the first trimming unit (10) and the second guides (32) of the second trimming unit (20) are arranged in the XZ plane and inclined with respect to the X axis.

8. Device according to claim 3, wherein the first guides (31) of the first trimming unit (10) and the second guides (32) of the second trimming unit (20) are arranged in the XZ plane and inclined with respect to the X axis.

9. Device according to claim 6, wherein the first guides (31) of the first trimming unit (10) and the second guides (32) of the second trimming unit (20) are arranged in the XZ plane and inclined with respect to the X axis.

10. Device according to claim 7, wherein the first guides (31) and the second guides (32) are parallel and form with the X-axis an angle of 45°.

11. Device according to claim 8, wherein the first guides (31) and the second guides (32) are parallel and form with the X-axis an angle of 45°.

12. Device according to claim 9, wherein the first guides (31) and the second guides (32) are parallel and form with the X-axis an angle of 45°.
